(19) United States
(12) Patent Application Publication
(10) Pub. No.: US 2026/0259699 A1
(43) Pub. Date: Sep. 3, 2026

(54) PRUNING OF SIMILAR AST SUBTREES FOR CODE SIMILARITY SEARCH

(71) Applicant: Oracle International Corporation, Redwood Shores, CA (US)

(72) Inventors: Felix Schmidt, Zurich (CH); Samuele Meta, Zurich (CH); Thierry Lavoie, Calgary (CA)

(73) Assignee: Oracle International Corporation, Redwood Shores, CA (US)

(21) Appl. No.: 19/068,923

(22) Filed: Mar. 3, 2025

(51) Int. Cl. G06F 8/30

(52) U.S. Cl. CPC G06F 8/30

(57) ABSTRACT

An example method comprises accessing a set of code for which to generate an index for code retrieval, and determining a hierarchy of candidate subsets of the set of code for which to make a determination whether to separately store vector embeddings of the candidate subsets in the index. The method also comprises determining, for a particular subset of the candidate subsets, an ancestor that is closest to the particular subset and for which a determination has been made to separately store a vector embedding in the index. The method also comprises determining a relative amount of content of the ancestor that is shared by the particular subset. The method also comprises generating and storing, in the index for code retrieval from the set of code, a particular vector embedding of the particular subset based at least in part on determining that the relative amount does not satisfy a threshold.

### BACKGROUND

Code comparison tools are software tools designed to compare code. For example, a code comparison tool may compare two code snippets to determine whether they accomplish the same functionality. Some code comparison tools analyze code syntax, structure, variable names, comments, and/or other code elements to support code comparison. Some code comparison tools differentiate between code by finding common algorithms or design patterns, e.g., to reduce false positives or to facilitate a nuanced analysis of the code.

Code comparison tools are used in a variety of applications. For example, an educator can use a code comparison tool to check code in student assignments for potential instances of cheating or plagiarism (e.g., a piece of code may have been copied from another source). As another example, a software developer can use a code comparison tool to assess and/or analyze software quality of a software project or to determine whether certain desirable or undesirable code is present. Regardless of the use case, code comparison can be costly and inaccurate due to the many ways that code can be expressed.

### BRIEF SUMMARY

In some embodiments, a computer-implemented method includes accessing a set of code for which to generate an index for code retrieval from the set of code. The method includes determining a hierarchy of candidate subsets of the set of code for which to make a determination whether to separately store vector embeddings of the candidate subsets in the index for code retrieval from the set of code. The method also includes determining, for a particular subset of the hierarchy of candidate subsets, an ancestor that is closest to the particular subset and for which a determination has been made to separately store a vector embedding in the index for code retrieval from the set of code. The method further includes determining a relative amount of content of the ancestor that is shared by the particular subset. The method also includes generating and storing, in the index for code retrieval from the set of code, a particular vector embedding of the particular subset based at least in part on determining that the relative amount does not satisfy a threshold. The method further includes determining, for another particular subset of the hierarchy of candidate subsets, another ancestor that is closest to the other particular subset and for which another determination has been made to separately store another vector embedding in the index for code retrieval from the set of code. The method also includes determining another relative amount of content of the other ancestor that is shared by the other particular subset. The method further includes determining not to separately store a vector embedding specific to the other particular subset in the index based at least in part on determining that the other relative amount satisfies the threshold. The method also includes storing the other vector embedding of the other ancestor in the index for code retrieval from the set of code. The method further includes using the index to identify code similar to a content vector embedding.

In some embodiments, a system is provided that includes one or more data processors and a non-transitory computer-readable storage medium containing instructions which, when executed on the one or more data processors, cause the one or more data processors to perform part or all of one or more methods disclosed herein.

In other embodiments, a computer-program product is provided that is tangibly embodied in a non-transitory and/or transitory machine-readable storage medium and that includes instructions configured to cause one or more data processors to perform part or all of one or more methods disclosed herein.

Cloud services, microservices, or other machine-hosted services may be offered that perform part or all of one or more methods disclosed herein. The machine-hosted services may be provided by a single machine, by a cluster of machines, or otherwise distributed across machines. The one or more machines may be configured to send and receive data, which may include instructions for performing the methods or results of performing the methods, via an application programming interface (API) or any other communication protocol.

In various embodiments, part or all of one or more methods disclosed herein may be performed by stored instructions such as a software application, computer program, or other software package installed in memory or other storage of a computing platform, such as an operating system, which provides access to physical or virtual computing resources. The operating system may provide access to physical or virtual resources of a mobile computing device, a laptop computing device, a desktop computing device, a server computing device, a container in a virtual machine on a computing device, or any other computing environment configured to execute stored instructions.

As used herein, the terms “first,” “second,” “third,” “fourth,” etc. are used as naming conventions to refer to separate items in a set of items or separate process instances of a set of process instances. These naming conventions do not imply ordering unless such ordering is explicitly noted using language specific to ordering, such as “before” or “after,” or unless such ordering is required to attain the expressly recited functionality, such as generating an item and later accessing the generated item.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

Various embodiments are described hereinafter with reference to the figures. It should be noted that the figures are not drawn to scale and that the elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure.

FIG. 1 illustrates a flow chart of an example process that selectively extracts code snippets for indexing.

FIG. 2 illustrates a system diagram showing an example code indexing system.

FIG. 3 illustrates a diagram of an example user interface showing extracted code snippets for indexing.

FIG. 4 illustrates a diagram of an example abstract syntax tree (AST).

FIG. 5 illustrates a diagram of example relationships between dominance threshold values, cosine similarity metrics, and size reductions of extracted code snippets.

FIG. 6 illustrates a diagram of an example system that performs AST-based splitting of a source code document.

FIG. 7 depicts a simplified diagram of a distributed system for implementing certain aspects.

FIG. 8 is a simplified block diagram of one or more components of a system environment by which services provided by one or more components of an embodiment system may be offered as cloud services, in accordance with certain aspects.

FIG. 9 illustrates an example computer system that may be used to implement certain aspects.

### DETAILED DESCRIPTION

Example systems and methods are described for pruning similar AST subtrees for code similarity search or other code comparison or code analysis. In various embodiments, the pruning similar AST subtrees for code similarity search is implemented using non-transitory and/or transitory computer-readable storage media to store instructions which, when executed by one or more processors of a computer system, cause display of a user interface and processing of received input to prune similar AST subtrees for code similarity search. The pruning similar AST subtrees for code similarity search may be implemented on a local or cloud-based computer system that includes processors and a display for showing the user interface to a user for pruning similar AST subtrees for code similarity search. The computer system may communicate with client computer systems for pruning similar AST subtrees for code similarity search and/or displaying results of code similarity search based on the pruning.

The steps described in individual sections may be started or completed in any order that supplies the information used as the steps are carried out. The functionality in separate sections may be started or completed in any order that supplies the information used as the functionality is carried out. Any step or item of functionality may be performed by a personal computer system, a cloud computer system, a local computer system, a remote computer system, a single computer system, a distributed computer system, or any other computer system that provides the processing, storage and connectivity resources used to carry out the step or item of functionality.

Code Analysis to Support Security, Reliability, and/or Efficiency

Code analysis is a process for examining source code to identify potential software issues such as bugs (e.g., syntax errors, coding standard violations, undefined values, etc.), security vulnerabilities (e.g., SQL injection, cross-site scripting (XSS), etc.), and/or in-efficiencies (e.g., performance bottlenecks, etc.). Static code analysis involves analyzing code without executing the code (e.g., static application security testing (SAST), etc.). Dynamic code analysis involves analyzing behavior of a computer program during runtime or while the program is running. Code analysis could facilitate improving software quality, software security, and/or software performance. In some scenarios, code analysis could facilitate saving time and improving accuracy of software processes such as data processing programs. Code analysis could also facilitate verifying code compliance with industry standards, such as various performance standards and/or security standards.

In some examples, code analysis may be performed or assisted using one or more software tools. For example, code similarity search tools can be used to find sections of code that have similar issues, dependencies, etc., as those that were identified in a particular code section. This may be beneficial in various scenarios. By way of example, a security vulnerability may have been recently discovered in a particular code section of a codebase and where the codebase includes millions or billions of lines of code. In this scenario, a code similarity search tool can be used to quickly find other similar code sections which may potentially have the same or similar security vulnerability. Robust code analysis could facilitate other software development processes as well, such as automated software test generation and/or updating code test patterns efficiently or automatically when code updates are integrated into a codebase.

Separating Code into Subsets to Support Fine-Grained Code Analysis

Example systems are described herein for separating or splitting source code into smaller subsets or code snippets to support fine-grained code analysis. By way of example, fine-grained code analysis may be needed to efficiently perform certain software development processes such as debugging, compiling, program analysis, among other examples. For example, compilers and/or interpreters may need to understand the structure of the source code via code analysis to be able to process the source code into an executable form or other form for deployment. As another example, machine learning (ML) based code similarity search systems may need to create vector embeddings of code snippets. Traditional code splitting techniques include character block-wise splitting (e.g., source code split into blocks having a particular character size). However, this approach may be less suitable for fine-grained code analysis due to a potentially arbitrary nature of logic included in each fixed-size code block.

Accordingly, the present disclosure includes example systems and methods that provide robust and/or fine-grained code analysis by splitting a codebase into logically meaningful code snippets (e.g., code snippets representing functions, classes, logical blocks, etc.) to enable, for example, training a machine learning model, configuring a large language model, and/or generating a search index for efficient code retrieval and other nuanced code analysis functionalities.

To facilitate this, some aspects herein include generating and/or using a syntax tree or abstract syntax tree (AST) to analyze a code set and/or split the code set into one or more code subsets. A syntax tree or abstract syntax tree (AST) is a data structure used to represent the structure of a program or code snippet. For example, an AST may include a tree representation of an abstract syntactic structure of source code written in a formal language. Each node of the AST may denote a language construct or logical block or other logically meaningful code subset. Furthermore, the AST may include a subtree corresponding to a logical block, a class, a function, a language construct (e.g., loop, conditional statement, etc.), function calls, and/or any other logically meaningful code subset within an ancestor code set corresponding to an ancestor of the subtree in the AST. Furthermore, an AST may include any number of subtrees, subtrees-of-subtrees, etc., according to a syntactic structure of code represented by the AST.

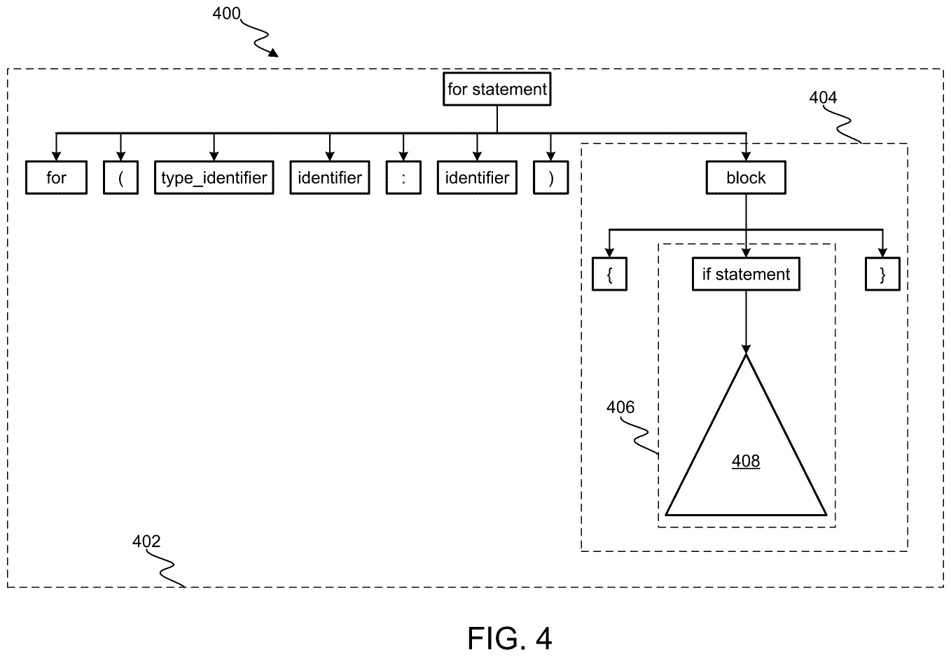

For instance, consider the following example code snippet, which may also be referred to hereinafter as ‘CS1’. An example AST of CS1 is depicted in FIG. 4.

Code Snippet 1 (CS1):

```
for (MemoryBlock page : pageTable) {
  if (page != null) {
    if (logger.isDebugEnabled( )) {
      logger.debug(“unreleased page: { } in task { }”, page,
      taskAttemptId);
    }
    page.pageNumber =
    MemoryBlock.FREED_IN_TMM_PAGE_NUMBER;
    memoryManager.tungstenMemoryAllocator( ).free(page);
  }
}
```

In this example, an AST of CS1 may have a first subtree corresponding to the entire code snippet, a second subtree corresponding to a code snippet that includes the outermost if statement and its body block (e.g., ‘if (page!=null) { . . . }’), a third subtree corresponding to a code snippet that includes the innermost if statement and its body block (e.g., ‘if (logger.isDebugEnabled( )) { . . . }’), and so on. The size of each subtree may be defined as the number of AST nodes in the subtree. Different techniques for splitting up code into a syntax tree may be used, and various syntactical expressions may be separated or grouped together according to the different techniques. Regardless of how individual syntactical expressions are treated, the syntax tree splits the code into subsets or subsections based on the syntactical expressions within the code.

By extracting code snippets corresponding to subtrees of an AST (or the entire AST), an example system may advantageously split code into logically meaningful parts to facilitate efficient indexing of various parts of the code. For example, a search index can be generated that includes an indexed item for each extracted code snippet corresponding to a subtree. Further, the extracted code snippets can be processed (e.g., as separate vector embeddings) to train a machine learning model effectively to facilitate searching for a particular part of CS1 that is similar to a search input (e.g., a content vector embedding corresponding to another code snippet in a search request for similar code, etc.) by training the machine learning model to understand patterns in the logically meaningful extracted code snippets.

### Pruning Partially Redundant Subsets to Support More Efficient Fine-Grained Code Analysis

In some scenarios, a total size of multiple code subsets extracted from a large code set according to the example AST-based code splitting approach described above may be very large (e.g., larger than the original code set) due to overlapping content repeated in the extracted code subsets. For instance, in the example of CS1, rather than extracting a single code snippet for CS1, multiple code snippets comprising different (partially overlapping) subsets of CS1 corresponding to different subtrees and/or subtrees-of-subtrees in the AST may be extracted as separate code snippets. Thus, extracting and processing code snippets from a source code file corresponding to every possible AST subtree or subtree-of-subtree may be less efficient than extracting a fewer number of code snippets from the source file, as some code snippets may be very similar (e.g., redundant) subsets of other code snippets.

Accordingly, the present disclosure includes example systems and methods for pruning partially redundant code subsets to support more efficient and/or fine-grained code analysis.

In one example, a system described herein is configured to evaluate an extent to which a first AST subtree dominates a second AST subtree and decide whether to extract code snippet(s) for both subtrees or for one of the subtrees accordingly. The term ‘dominate’ may be used herein to describe a relative size (e.g., number of AST nodes) of two AST subtrees or a relative amount of content in two code snippets (e.g., where one code snippet is a subset of the other code snippet) corresponding to the two subtrees. Referring back to the example of CS1 above for instance, the overall AST of CS1 is dominated by the body block of the for statement (i.e., most of the code in CS1 overlaps the code in the body block of the for statement), and the body block of the for statement is dominated by the outermost if statement and its body block.

The following example equation describes an example computation that can be performed by the system to compute a dominance (e.g., dominance factor, dominating factor, etc.) of an AST subtree relative to a parent or other ancestor of the subtree.

$$dominance = \frac{\vert subtree \vert}{\vert parent \vert}$$

In this example, the term |subtree| corresponds to a size of a particular subtree (i.e., number of AST nodes in the subtree), and the term |parent| corresponds to a size of a parent or ancestor tree or subtree that includes the particular subtree. In various embodiments, the corresponding sizes may include or exclude certain content, such as comments, redundant or superfluous syntactical markings in the code, markings that are irrelevant or of limited relevance to the analysis being performed, or other stop words or stored expressions for exclusion.

Advantageously, in some examples, computing dominance according to the example equation described above may indicate a similarity or an extent of overlap between a code snippet and a subset of the code snippet in a relatively less computationally expensive manner than comparing textual or vector embedding representations of the two code snippets. Furthermore, in some examples, computing the dominance in this manner may indicate overlap of the associated code snippets with respect to their abstract syntax, i.e., while potentially avoiding comparison bias associated with content unrelated to syntactical or logical behavior of the underlying code in the two code snippets (e.g., lengths of variable names, lengths of function names, comment text, variable values, etc.).

In some aspects, an example system is configured to extract and/or index a subtree (or code snippet associated with the subtree) based on a dominance factor of the subtree relative to a parent or ancestor of the subtree being below a threshold. For example, if the dominance factor is below the threshold, a code subset associated with the subtree may be deemed to be sufficiently different from a code set (e.g., which includes the code subset) associated with a parent or ancestor of the subtree. In this case, for example, the system may decide to extract and/or index a separate code snippet for the subtree as it is likely to be sufficiently distinct from a code snippet of the parent or ancestor subtree. On the other hand, for example, if the dominance factor is above the threshold, the example system may decide to prune the subtree (e.g., by not extracting and/or indexing a separate code snippet for the subtree) because a code snippet of the subtree may be deemed redundant because it may significantly overlap a code snippet of its parent or ancestor subtree.

Thus, some example methods herein involve reducing a number of extracted subtrees (and/or code snippets) of an AST, without necessarily omitting information or source code from an index associated with the AST (e.g., content of a redundant code snippet that is not indexed is still present within another indexed code snippet of a parent or ancestor subtree, etc.). As such, the present method may enable a smaller storage footprint (e.g., 20%, 25%, etc.), faster indexing, and/or faster search query results.

Continuing with the example of CS1 for instance, two example code snippets ‘CS2’ and ‘CS3’ corresponding to two possible subtrees of the AST of CS1 are presented below.

```
Code Snippet 2 (CS2):
for (MemoryBlock page : pageTable) {
  if (page != null) {
    if (logger.isDebugEnabled( )) {
      logger.debug(“unreleased page: { } in task { }”, page,
      taskAttemptId);
    }
    page.pageNumber =
    MemoryBlock.FREED_IN_TMM_PAGE_NUMBER;
    memoryManager.tungstenMemoryAllocator( ).free(page);
  }
}
Code Snippet 3 (CS3):
{
    if (logger.isDebugEnabled( )) {
      logger.debug(“unreleased page: { } in task { }”, page,
      taskAttemptId);
    }
    page.pageNumber =
    MemoryBlock.FREED_IN_TMM_PAGE_NUMBER;
    memoryManager.tungstenMemoryAllocator( ).free(page);
}
```

In this example, CS2 is a code snippet (e.g., parent snippet) corresponding to a subtree that is AST of CS1 itself. Thus, CS2 includes all the code of CS1. CS3 is a code snippet (e.g., redundant snippet) that corresponds to another subtree of the AST of CS1 (e.g., the body block of the outermost if statement). In this example, the dominance or domination value computed for CS3 may be 0.9 and the threshold dominance may be 0.8. Thus, in this example, CS2 may be included in the index (e.g., because it has no parent subtree) and CS3 may be considered a redundant snippet that is not included in the index (e.g., because its dominance value of 0.9 is greater than the threshold dominance value of 0.8).

### Embedding Content of Code Sets and Subsets to Support Code Analysis

In line with the discussion above, the extracted code snippets added to the index can be used to generate vector embeddings. Vector embeddings are numerical representations of data (e.g., the code snippets) as an array of numbers that machine learning (ML) models can process to capture their meaning and/or relationships. Thus, vector embeddings can help a computer find patterns in data, even when the data is complex. By converting the extracted and/or indexed code snippets into vector embeddings, an example system can compare various vector embeddings to search for similar code. For example, if a user submits a piece of code in a search query, an example system may convert the piece of code into a content vector embedding and compare the content vector embedding with the vector embeddings of the indexed code snippets to find an indexed code snippet that is similar to the piece of code in the search query.

In some configurations, the vector embeddings are used as training data for training an ML model (e.g., neural network or other embedding model). For instance, the ML model can then be used to predict a similar code snippet to a code snippet associated with a search query.

In some configurations, the system is configured to use a large language model (LLM) to facilitate performing the code similarity search. For example, the system may provide the vector embeddings of the extracted and/or indexed code snippets via a retrieval-augmented-generation (RAG) interface of the LLM so as to configure the LLM to search for code using the vector embeddings. Next, a user can submit a natural code search query, i.e., a question about code in a natural language format, to the system. In this example, the system can then prompt the LLM with the natural language search query and the LLM can use the vector embeddings to identify an indexed code snippet based on the natural language search query. For instance, the user may ask a question such as “is there code that finds an entry of a list in Python?,” and the system may then provide an indexed code snippet as a response to the search query.

In one example, a configuration command may be provided to a query processing service in a user session or connection with a client to select a particular large language model for use with the natural language of incoming queries on a user session, or for given requests, from the client. For example, the “openai” large language model provider may be chosen with named credentials. The model used may be, for example, gpt-3.5-turbo. Other example providers include, but are not limited to, Cohere, Azure AI, Google PaLM 2, Llama 3, etc. In various other examples, default credentials may be used by the query processing service. In one embodiment, the credentials include user-specific credentials, such as a user-specific inner session identifier, that allow the LLM service to switch between supporting different users within the same LLM session using the same LLM connection credentials. In this embodiment, context from a given user may be retrieved using the user-specific inner session identifier before processing a natural language query for the given user. In another embodiment, a code analysis tool uses the same LLM service for users but may use different LLM sessions for different users. The LLM session may be authenticated using a token that is established to refer to a particular user session. The token may be passed by the code analysis tool to establish or re-establish the authenticated session with the LLM and begin sending prompts.

In various embodiments, prompts are generated to use information about a data schema, such as data that is formatted in a hierarchical format (e.g., JSON, XML, or another structured and delimited format that distinguishes between members at different levels of the hierarchy).

The prompts may also specify a format for providing the reply, through example valid responses to example requests, and/or through explicit description of the requested format.

In various embodiments, the techniques herein refer to “a prompt” being generated, and “the prompt” is intended to refer to a single request or multiple requests that, together, serve to prompt the LLM. LLMs may be prompted in a same session using one or multiple requests as the prompt to perform functionality, and the delineation between requests to the LLM can be split in any manner in accordance with the techniques described herein.

In one embodiment, validating the content of the LLM reply includes verifying that the reply conforms to the correct length and data type constraints, if any. If the LLM reply includes a data structure consumable by a code analysis tool, the validation may include verifying that the data structure conforms to a schema expected or used by code analysis tool.

In various embodiments, the code analysis tool may provide a configuration interface to the user for configuring a workflow for handling LLM replies that could not be validated. The configuration could specify that the LLM may be re-prompted with the non-validated reply used as a non-conforming example that should be avoided, or to trigger an error message.

In one embodiment, JSON results from the LLM are parsed by searching for delimiters such as “{” and “}” or “[” and “]” in the response. The values may be embedded in the delimiters and extracted from the embedded structure to determine values predicted by the LLM. The consumable JSON object may be separated from a remainder of the response for consumption by the code analysis tool to create an executable or otherwise consumable structure to trigger functionality of the code analysis tool.

### Retrieving Code Similar to a Query or Other Input

Example systems and methods are described herein for generating an index for code retrieval (e.g., search index) to facilitate identifying similar code (e.g., search query or other input).

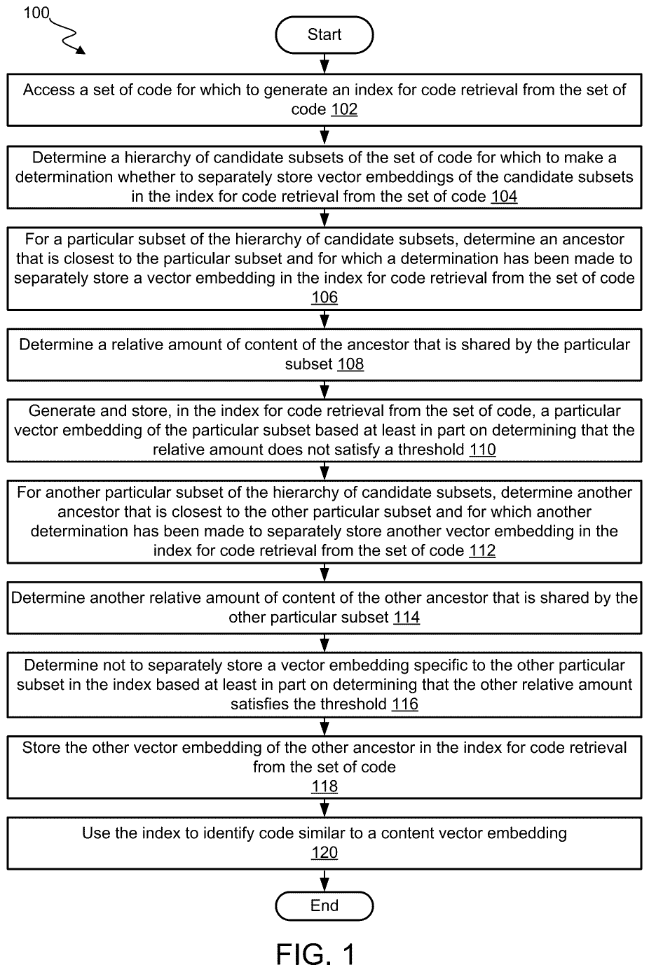

FIG. 1 illustrates a flow chart of an example process 100 that selectively extracts code snippets for indexing. The process 100 begins at 102 where an example code indexing system accesses a set of code for which to generate an index for code retrieval from the set of code. For example, the code indexing system may receive an indication of the set of code (e.g., source code file name, code entry, etc.) via a user interface and/or may access the set of code from a codebase repository.

At 104, the example code indexing system determines a hierarchy of candidate subsets of the set of code for which to make a determination whether to separately store vector embeddings of the separate candidate subsets in the index for code retrieval. For example, the code indexing system may generate or access one or more ASTs representing the set of code. Further, the example code indexing system may identify subsets of the set of code as code snippets corresponding to subtrees of the AST(s). Thus, in some examples, the process 100 also includes identifying the hierarchy of candidate subsets of the set of code using an abstract syntax tree, and identifying the hierarchy of candidate subsets of the set of code by identifying one or more subtrees of the abstract syntax tree.

In some examples, the process 100 also includes identifying a candidate subset of the set of code based on the candidate subset being associated with a node having at least one child node in the abstract syntax tree. For example, leaf nodes in the abstract syntax tree may be ignored and actual subtrees (i.e., nodes having one or more child nodes in the AST) are considered for identifying a candidate subset of the set of code.

At 106, the example code indexing system determines, for a particular subset of the hierarchy of candidate subsets, an ancestor that is closest to the particular subset and for which a determination has been made to separately store a vector embedding in the index for code retrieval. For example, the code indexing system may identify CS1 as the ancestor of a code snippet (i.e., the particular subset) corresponding to a portion of CS1 (e.g., a code snippet that includes the innermost if statement in CS1, etc.).

At 108, the example code indexing system determines a relative amount of content of the ancestor that is shared by the particular subset. For example, the code indexing system may calculate a ratio of a size of an AST subtree corresponding to the particular subset relative to a size of an AST subtree corresponding to the ancestor.

At 110, the example code indexing system generates and stores, in the index for code retrieval, a particular vector embedding of the particular subset based at least in part on determining that the relative amount does not satisfy a threshold. For example, if the threshold dominance is 0.8 and the computed dominance value of a code snippet is 0.5, the example code indexing system may generate a vector embedding for the code snippet because its dominance value (e.g., 0.5) does not satisfy (e.g., is less than) the threshold dominance value of 0.8.

In some examples, the particular vector embedding is based at least in part on a large language model output from analyzing content of the particular subset. For example, the code indexing system may use a large language model to process the content of the particular subset and generate the particular vector embedding.

At 112, the example code indexing system determines, for another particular subset of the hierarchy of candidate subsets, another ancestor that is closest to the other particular subset and for which another determination has been made to separately store another vector embedding in the index for code retrieval. For example, the code indexing system may identify CS2 as the ancestor of CS3 (i.e., the other particular subset).

In some examples, the other particular subset is an ancestor of the particular subset and the ancestor is a superset of the particular subset and the other particular subset. Referring to FIG. 4 for example, the ancestor may be the entire ‘for statement’ (e.g., subtree 402), the other particular subset may be the body block of the for statement (e.g., subtree 404), and the particular subset may be the if statement (e.g., subtree 406).

In some examples, the particular subset is the other ancestor of the other particular subset and the particular subset is a superset of the other particular subset. Continuing with the example of FIG. 4 for instance, the other ancestor may be outermost if statement (e.g., subtree 406) and the other particular subset may be the innermost if statement of CS1 (not shown in FIG. 4).

At 114, the example code indexing system determines another relative amount of content of the other ancestor that is shared by the other particular subset. For example, the code indexing system may calculate a dominance value of 0.9 for CS3 (i.e., relative to CS2).

At 116, the example code indexing system determines not to separately store a vector embedding specific to the other particular subset in the index based at least in part on determining that the other relative amount satisfies the threshold. For example, the code indexing system may determine not to separately store a vector embedding for CS3 because its dominance value (e.g., 0.9) is greater than the dominance threshold (e.g., 0.8). For instance, CS3 may be deemed to significantly overlap CS2 and thus no separate vector embedding for CS3 is needed for the index.

At 118, the example code indexing system stores the other vector embedding of the other ancestor in the index for code retrieval. For example, the code indexing system may store a vector embedding for CS2 (e.g., but not for CS3).

At 120, the example code indexing system uses the index to identify code similar to a content vector embedding. For example, the code indexing system may receive a piece of code from a user via a user interface, and use the index to search for similar code snippets by generating a content vector embedding for the piece of code and comparing it (e.g., computing a vector distance, etc.) with the vector embeddings in the index.

In some examples, the code indexing system using the index to identify code similar to the content vector embedding at 120 comprises determining a cosine similarity between the content vector embedding and each of the ancestor vector embedding, the other ancestor vector embedding, and the particular vector embedding. In these examples, the process 100 may also include the code indexing system selecting, as similar, one of the ancestor vector embedding, the other ancestor vector embedding, or the particular vector embedding without selecting, as similar, at least one other of the ancestor vector embedding, the other ancestor vector embedding, or the particular vector embedding. For example, the code indexing system may compute a cosine similarity distance between vectors representing the content vector embedding and the other vector embeddings to select a given vector having the smallest cosine similarity vector distance.

In some examples, the code indexing system using the index to identify code similar to the content vector embedding at 120 comprises determining a cosine similarity between the content vector embedding and each of the ancestor vector embedding and the particular vector embedding, and selecting, as similar, the particular vector embedding without selecting, as similar, the ancestor vector embedding. For example, if two vector embeddings are similar to the content victor embedding, the code indexing system may select the smaller code snippet (e.g., the particular subset) for retrieval as similar to the content vector embedding.

In some examples, the process 100 also includes the example code indexing system determining the content vector embedding based on a search query comprising natural language content describing code. For example, the code indexing system can use a large language model to determine a content vector embedding by processing natural language input such as speech input (e.g., “find code for managing memory pages,” etc.).

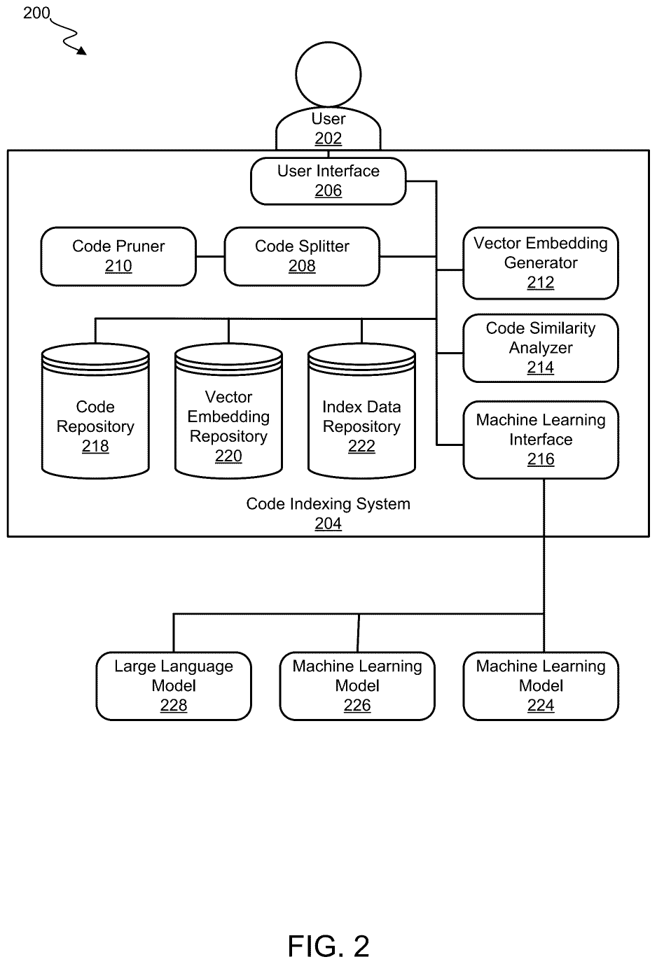

FIG. 2 illustrates a system diagram 200 showing an example code indexing system 204. The code indexing system 204 includes a user interface 206, a code splitter 208, a code pruner 210, a vector embedding generator 212, a code similarity analyzer 214, a machine learning interface 216, a code repository 218, a vector embedding repository 220, and an index data repository 222.

The user interface 206 includes any combination of hardware and/or software configured to receive inputs and/or provide outputs to a user 202 of the code indexing system 204. For example, the user interface 206 may include a graphical user interface (GUI) that receives a search query or other input indicative of a piece of code and then provide output indicating one or more code snippets similar to the piece of code.

The code splitter 208 includes any combination of hardware and/or software configured to receive a set of code and provide one or more code subsets by splitting the set of code into the code subset(s) according to an AST-based approach. For example the code splitter 208 may generate an AST for a set of code and use the AST to select one or more AST subtrees corresponding to candidate subsets of the set of code for inclusion in an index for code retrieval.

The code pruner 210 includes any combination of hardware and/or software configured to prune the extracted code subset(s) to remove one or more of the code subset(s) that significantly overlap other code subsets. For example, the code pruner 210 may use a dominance threshold to decide whether or not to include a particular code subset in an index for code retrieval.

The vector embedding generator 212 includes any combination of hardware and/or software configured to generate a vector embedding for each code subset selected for inclusion in the index for code retrieval. For example, the vector embedding generator 212 may use the machine learning interface 216 to determine numerical values representing patterns associated with the code subsets (i.e., the vector embeddings).

The code similarity analyzer 214 includes any combination of hardware and/or software configured to analyze similarity between two sets of code. For example, the code similarity analyzer 214 may perform a vector distance computation to identify similarities between a vector embedding corresponding to a first set of code and another vector embedding corresponding to a second set of code. The vector distance may indicate an extent to which the two sets of code are similar.

The machine learning interface 216 includes any combination of hardware and/or software configured to interface with one or more of machine learning model 224, 226 and/or large language model 228. For example, the machine learning interface 216 may be configured to train the machine learning model 224 and/or 226 to predict vector embeddings for pieces of code. As another example, the machine learning mode 216 may configure the large language model 228 to generate and/or predict vector embeddings by prompting the large language model 228 using a retriever augmented generation (RAG) process.

The code repository 218 includes any combination of hardware and/or software configured to store one or more source code files, a codebase, or any other representation of code. To that end, the code repository 218 may include a database, a file server, or any other suitable data storage medium.

The vector embedding repository 220 includes any combination of hardware and/or software configured to store vector embeddings corresponding to one or more sets of code and/or one or more subsets of a particular set of code. To that end, the vector embedding repository 220 may include a database, a file server, or any other suitable data storage medium.

The index data repository 222 includes any combination of hardware and/or software configured to store index information (e.g., location of code associated with vector embedding, etc.) corresponding to one or more sets of code and/or one or more subsets of a particular set of code. To that end, the vector embedding repository 220 may include a database, a file server, or any other suitable data storage medium.

Relevant information may be identified for inclusion in the index for code retrieval, as a vector embedding used to train machine learning models 224 and/or 226 or as RAG or to configure a large language model prompt of the large language model 228 for instance. For example, the code indexing system 204 can compare two pieces of code by using a common embedding technique across both a first piece of code and a second piece of code. The common embedding technique may output vector embeddings for code snippets, and a similarity of the vector embeddings may be determined using a variety of vector distance techniques to find code vector embeddings that are closest or within a threshold distance of other vector embeddings (e.g., a content vector embedding representing a search query or other input).

In one embodiment, vectors of similar distance may be determined for an input vector using a vector database. The vector database may receive, as input, a content vector embedding representing a piece of code in a search query or other input. The vector database may then identify, using vector distances, another set of data, such as a code snippet stored in the code repository database 218 that is closest to the input vector embedding.

The code similarity analyzer 214 may determine similarities between vectors by calculating a similarity measure and optionally ranking pairs based on similarity or comparing the similarity measure to a threshold value. For numerical or vector data, the data code similarity analyzer 214 may use any distance function or other method of determinations of numerical or vector similarities, such as Cosine Distance, the Euclidean Distance, the Pearson Correlation Coefficient, the Manhattan Distance, the Minkowski Distance, the Hamming Distance, the Chebyshev Distance, the Jaccard Distance, the Sorensen-Dice Distance, the Pearson correlation coefficient, the Levenshtein distance, or any other means of calculating correlation. For text data, the correlation may be determined by first converting the text to embeddings in vector space in a large language model, which can then be compared using any of the above methods for determining the similarity between vectors. The text embeddings may reduce semantic meanings within the text to numerical values corresponding to the detected semantic meanings. In this way, the correlation between columns is based on the meanings of the words of the text data.

The distance or similarity analysis may be performed on the whole vector embedding or by breaking up vectors into components to determine correlation of corresponding components across the vectors. For example, a first vector and a second vector may each include a component that indicates a method that includes a loop, and the information about the loop may be correlated across vectors even though the rest of the vector is not correlated. A correlation or similarity between vectors may be determined by comparing the correlation determined according to the similarity measure to a similarity threshold. The vectors may be counted as similar if the similarity measure exceeds the similarity threshold. In an alternative embodiment, the vectors may be compared to determine correlation clusters, where columns or components of the vectors or vectors themselves are determined to be part of a cluster if the correlation between all combinations of columns, components, or vectors in the cluster is above a certain threshold.

A Pearson Correlation Coefficient between two vectors is calculated as a ratio between the covariance between the vectors and the product of the standard deviations between the two vectors. A correlation coefficient of 1 represents identical vectors, a correlation coefficient of −1 represents opposite vectors, and a correlation coefficient of 0 represents vectors that are not correlated.

A Cosine Distance or cosine similarity between two vectors is determined by calculating a cosine of the angle between the two vectors. A result of 1 represents a cosine similarity between two identical, a result of −1 represents a cosine similarity between two opposite vectors, and a result of 0 represents a cosine similarity between two unrelated or orthogonal vectors.

A Euclidean Distance is determined by calculating a square root of a sum of the squares of the distances between components of the two vectors. The higher the Euclidean distance, the lower the similarity between the components of the vectors used in the calculation.

A Manhattan Distance is calculated as a sum of the absolute differences between components of the vectors. The higher the Manhattan Distance, the lower the similarity between the components of the vectors used in the calculation.

A Minkowski Distance is calculated as the p-th root of the sum of the absolute differences between components of the vectors raised to a power, p, for each component pair. The Minkowski Distance equals the Manhattan Distance when p=1 and the Euclidean Distance when p=2. The higher the Minkowski Distance, the lower the similarity between the components of the vectors used in the calculation.

A Hamming Distance between two vectors is determined based on how many positions at which corresponding components of the vectors are different or sufficiently different. For each component pair in the vectors that are different, a counter is incremented. The Hamming Distance is the total counter for the vectors across all component pairs.

A Chebyshev Distance between two vectors is calculated as the greatest of the absolute differences among the vectors' corresponding components. The largest absolute difference among all the pairs of components is the Chebyshev Distance. The larger the Chebyshev Distance, the lower the similarity between the vectors.

A Jaccard Distance between two vectors is calculated as a ratio between the size of the intersection between the vectors (based on elements in common between the vectors) to the size of the union between the vectors (based on elements in either or both of the vectors). Jaccard Similarity is defined by the ratio, and Jaccard Distance is defined as one minus the Jaccard Similarity.

The Sorensen-Dice Similarity is calculated as two times the number of elements in common among the vectors divided by the sum of the number of elements in each vector. The Sorensen-Dice Distance is one minus the Sorensen-Dice Similarity.

A Levenshtein Distance is a string similarity metric used to measure the minimum number of single-character allowed operations (insertions, deletions, or substitutions) required to transform one string into another.

Regardless of the distance metric used, the code similarity analyzer 214 may be configured to determine whether an indexed code snippet is similar to code and/or a query about code. In an example, the code indexing system 204 may receive a search query, via the user interface 206, that includes a natural language query (e.g., natural code similarity search query). In this example, the code similarity analyzer 214 may determine that an indexed code snippet in the code repository 218 is similar to code described by the natural language query (e.g., “can you find code in Python for managing memory pages?”, etc.), and thus the code indexing system 214 may retrieve the identified code and provide it for display to the user 202 via the user interface 206.

### Example Applications of Compact Indexes to Approximate Code Retrieval

Example systems and methods described herein include a variety of applications of compact indexes to approximate code retrieval. On one hand, extracting and indexing a large number of code snippets from a source code file may result in a relatively more thorough or comprehensive index that is relatively expensive computationally to generate and/or store. On the other hand, selecting a smaller number of extracted code snippets for indexing may result in a less but sufficiently thorough or comprehensive index that is relatively less expensive computationally to generate and/or store. For example, in a scenario where the extracted and indexed code snippets are used as semantic embeddings to train a machine learning model, the processing power needed to train the machine learning model and generate vector embeddings for each code snippet may dramatically increase if the total number and/or size of the code snippets increases. Furthermore, some of the extracted code snippets or code subsets may be very similar to one another and thus separately indexing each of such similar code snippets may not necessarily improve the overall learning quality of the machine learning model. In some scenarios, the number of combinations of snippets may be prohibitively large without pruning, or the combinations of code snippets may be changing so rapidly, that indexing is not practically feasible, let alone further analysis of the indexed code, rendering comprehensive code analysis impossible in the absence of pruning.

Referring back to the example of CS1 for instance, indexing a code snippet corresponding to the for statement and separately indexing a code snippet corresponding to the body block of the for statement may not necessarily improve code analysis as the two code snippets considerably overlap one another. Thus, a single vector embedding for the for statement may be retrieved instead of a separate vector embedding for its body block without significantly affecting the code analysis process. Furthermore, the sensitivity or the extent to which code snippets are pruned (i.e., depending on the extent of overlap) can be controlled by adjusting the dominance threshold used to decide whether a code snippet is to be pruned from the index.

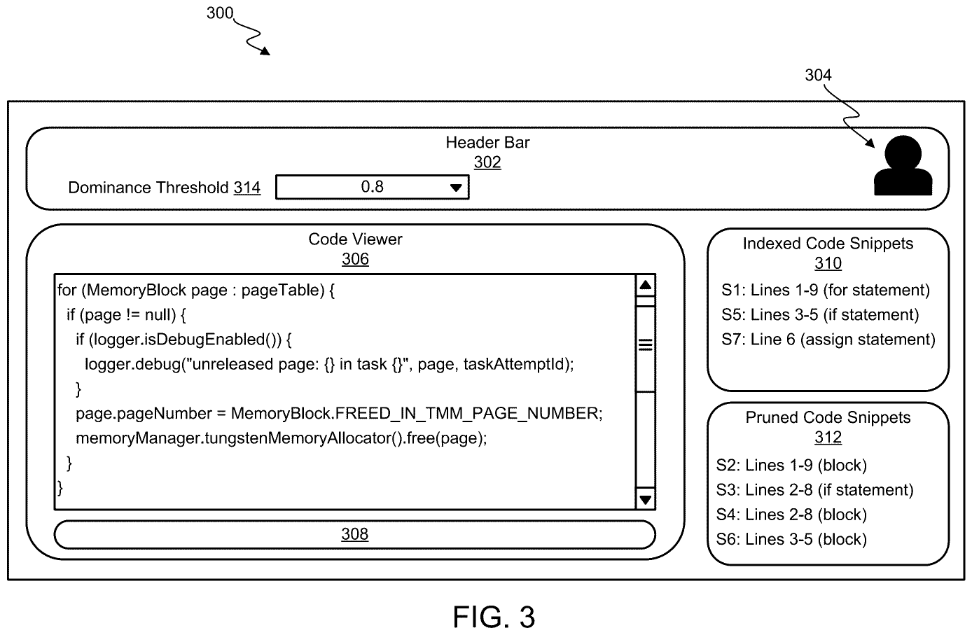

FIG. 3 illustrates a diagram of an example user interface 300 showing extracted code snippets for indexing. The user interface 300 includes a header bar 302, which may be a GUI element that includes various information about a user session of a user accessing the user interface 300. For example, a user account graphic indicator 304 may indicate a user account associated with the user session. The user interface 300 also includes a code viewer 306, an input element 308, an indexed code snippets listing 310, a pruned code snippets listing 312, and a dominance threshold input element 314.

The code viewer 306 may include a GUI element configured to display a set of code that is to be split into one or more code subsets that can be processed, for example, for inclusion in an index for code retrieval.

The input element 308 may include any combination of GUI input elements configured to select and/or submit a set of code for processing by an example code indexing system. For example, the input element 308 can be used to select a source code file or to enter source code for processing (e.g., splitting, indexing, etc.) by the code indexing system 204.

The indexed code snippets 310 may include a GUI element configured to display a listing of one or more code snippets extracted from the set of code and selected for inclusion in an index for code retrieval. For example, as shown, code snippets S1, S2, S3 may be selected as subsets of the set of code (e.g., shown in the code viewer 306) that do not overlap significantly, at least according to the dominance threshold 314.

The pruned code snippets 312 may include a GUI element configured to display a listing of one or more code snippets (e.g., corresponding to various subtrees of an AST of the code in code viewer 306) that are selected for pruning based on significantly overlapping (e.g., according to the dominance threshold 314) one or more of the indexed code snippets 310.

The dominance threshold 314 may include any input element configured to adjust the dominance threshold (e.g., maximum ratio of AST subtree sizes) used to decide whether a code snippet extracted according to the AST-based approach should be pruned or indexed.

FIG. 4 illustrates a diagram of an example AST 400 of CS1. In the illustrated example, three subtrees 402, 404, 406 of the AST 400 are illustrated by the dashed lines. For example, subtree 402 may correspond to the AST 400 itself and is associated with CS2. Subtree 404 may correspond to the body block of the ‘for statement’ in CS1. Subtree 406 may correspond to the outermost if statement in CS1. Furthermore, it is noted that the triangular shaped block 408 represents one or more nodes of the AST 400 that are omitted from the illustration of FIG. 4 for convenience in description. For example, although not shown, block 408 may include another subtree corresponding to the innermost ‘if statement’ of CS1, and so on.

In some aspects, an example code indexing system may use a configurable threshold (e.g., dominance threshold 314) to decide which AST subtrees to prune when generating an index for code retrieval. The table below shows example statistics collected using a large codebase for different reductions in the size of indexed code snippets for different values of the dominance threshold 314. The table also shows cosine similarity vector distances between vectors of pruned code snippets and vectors of their closest ancestors (and/or pairs of redundant code snippets). However, it is noted that the values in the example table below are only for the sake of example.

TABLE 1

| Threshold | 1.0 | 0.9 | 0.8 | 0.7 | 0.6 | 0.5 | 0.4 | 0.3 | 0.2 | 0.1 | 0.0 |
|---|---|---|---|---|---|---|---|---|---|---|---|
| Reduction | 0% | 25% | 39% | 49% | 54% | 57% | 60% | 65% | 72% | 75% | 75% |
| Cosine | — | 0.97 | 0.96 | 0.94 | 0.91 | 0.87 | 0.83 | 0.77 | 0.66 | 0.54 | 0.1 |

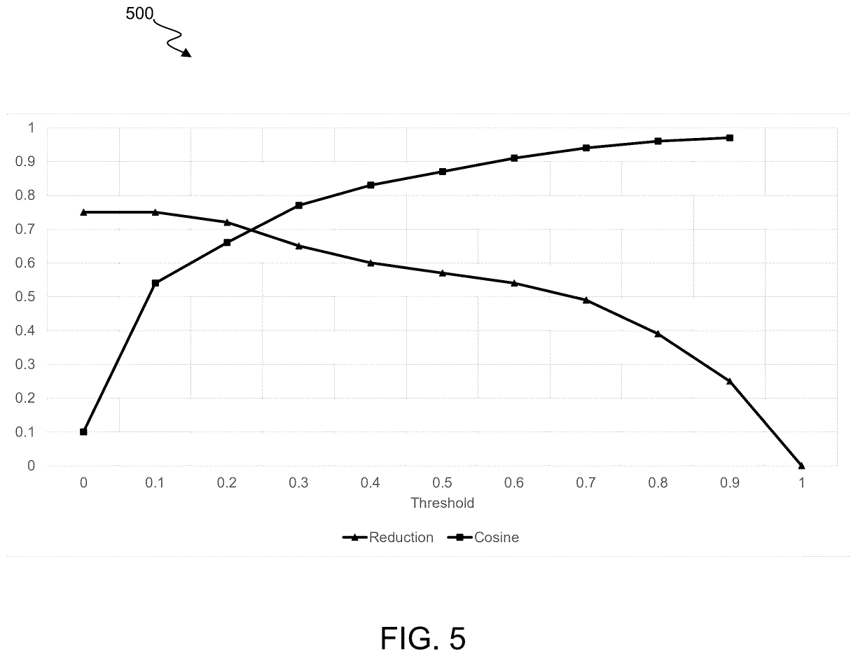

FIG. 5 illustrates a diagram 500 of the example relationships between dominance threshold values, cosine similarity metrics, and size reductions of extracted code of the example Table 1. In the illustrated example, the cosine distances indicate that higher values of the dominance threshold allow some of the similar (e.g., significantly overlapping) code snippets to be indexed even though significant reductions in the size and/or number of indexed code snippets can still be achieved. In this example, a user of the example code indexing system may select a dominance threshold value between 0.8 and 0.9 as such dominance threshold may allow detecting redundant code snippets with an average cosine similarity of above 0.95 with respect to a closest indexed code snippet. However, other threshold dominance values are possible as well depending on the various applications of the example code indexing system.

In some aspects, example systems and methods herein are configured to reduce the number of snippets that are selected for separate indexing to be embedded by a ML model for example. Thus, in some examples, a code indexing system herein may reduce the code snippets embedded as vectors in the ML model because a large number of vector embeddings may be associated with relatively high computational time and/or computational resource limitations to scalability. For instance, training the ML model may involve limited processing resources (e.g., GPU resources), and thus some examples herein may reduce redundant computation effort associated with processing redundant code snippets to reduce the amount of limited computational resources needed to train the ML model. Thus in some aspects, example systems and methods herein may increase performance of indexing and/or allow the system to run more indexing jobs by reducing computational costs (e.g., compute resources, storage resources) associated with indexing a larger number of code snippets while still achieving a same or similar query performance.

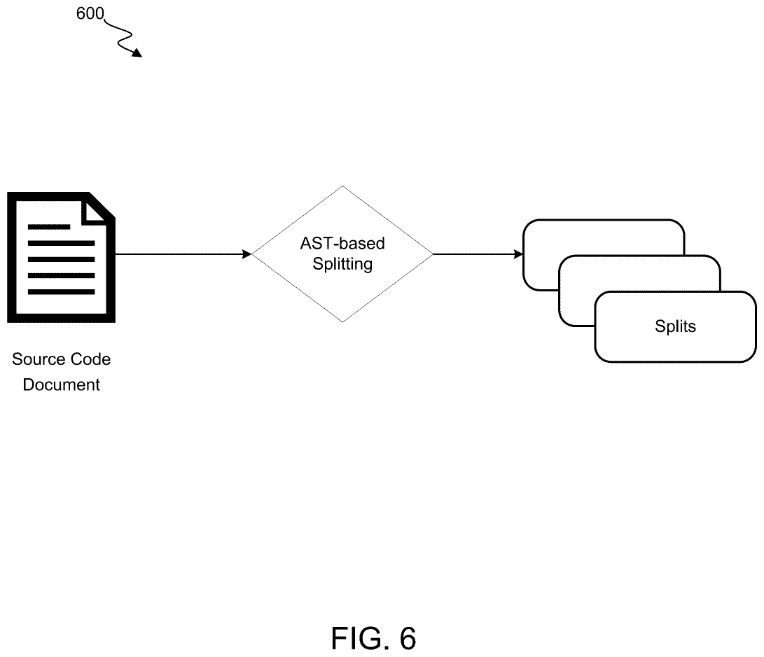

FIG. 6 illustrates a diagram of an example system 600 that performs AST-based splitting of a source code document. In some aspects, examples described herein involve document splitting. Document splitting is a process that can be used as part of one or more machine learning applications. In the illustrated example, source code files can be processed according to an AST-based splitting approach (e.g., code splitter 208 of the code indexing system 204) to extract one or more code snippets, in line with the discussion above. In some aspects, an example code indexing system is configured to perform document splitting according to an AST-based approach that leverages metrics about the code and AST(s) associated with the code in the document(s) to reduce redundancy. Example inputs and outputs of an example AST-based splitting technique are illustrated in FIG. 6. For example, the input may include source code documents (e.g., source files) and the splitting process results in overlapping code snippets (e.g., splits) of the source document.

Below is an example pseudo-code of an example algorithm to extract subtrees and/or subtrees-of-subtrees of an AST with redundancy elimination, in accordance with the present disclosure.

Code Snippet 4 (CS4):

```
func find_extracted_parent(node, extracted_nodes):
  if not node:
    return None
  if node in extracted_nodes:
    return node
  return find_extracted_parent(node.parent, extracted_nodes)
func extract_subtrees(ast, include_condition, threshold):
  result = set( )
  for node in ast:
    parent = find_extracted_parent(node, result)
    if parent:
      domination = size(node) / size(parent)
      if domination > threshold:
        continue
```

In this example, the function find extracted parent is configured to traverse an AST from a given node toward the root node and identify the most similar parent or ancestor node which has already been extracted as a snippet. For instance, the algorithm may assume that the closest ancestor node may have a highest potential similarity.

Furthermore, in this example, the function extract subtrees may iterate over the entire AST and extract subtrees which meet the include condition. For instance, the include condition may exclude nodes that do not have children nodes (e.g., leaf nodes), and so on. In some examples, in addition to the include conditions, the function extract trees may check the domination factor of the node with its closest ancestor which has already been included in the result set (i.e., the set of nodes selected for inclusion in the index for code retrieval).

In some aspects, an example system may be configured to perform the process 100 regardless of (e.g., independently of) the programming language of specific pieces of code in the source code file(s), for example, by leveraging the properties of the AST. For instance, language constructs specific to a particular programming language may be considered indirectly as they form subtrees in the AST.

### Computer System Architecture

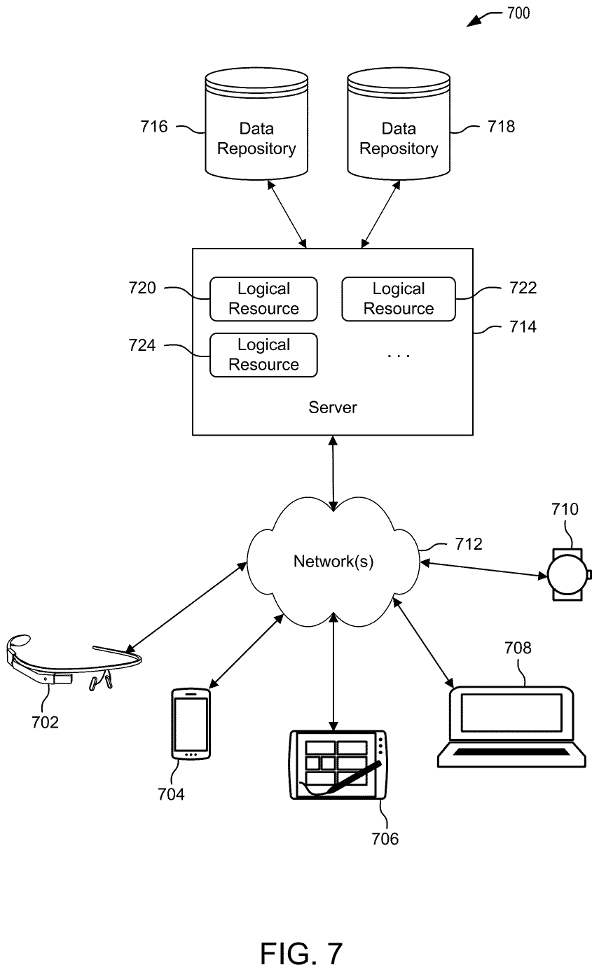

FIG. 7 depicts a simplified diagram of a distributed system 700 for implementing an embodiment. In the illustrated embodiment, distributed system 700 includes one or more client computing devices 702, 704, 706, 708, and/or 710 coupled to a server 714 via one or more communication networks 712. Clients computing devices 702, 704, 706, 708, and/or 710 may be configured to execute one or more applications.

In various aspects, server 714 may be adapted to run one or more services or software applications that enable techniques for pruning similar AST subtrees for code similarity search.

In certain aspects, server 714 may also provide other services or software applications that can include non-virtual and virtual environments. In some aspects, these services may be offered as web-based or cloud services, such as under a Software as a Service (SaaS) model to the users of client computing devices 702, 704, 706, 708, and/or 710. Users operating client computing devices 702, 704, 706, 708, and/or 710 may in turn utilize one or more client applications to interact with server 714 to utilize the services provided by these components.

In the configuration depicted in FIG. 7, server 714 may include one or more components 720, 722 and 724 that implement the functions performed by server 714. These components may include software components that may be executed by one or more processors, hardware components, or combinations thereof. It should be appreciated that various different system configurations are possible, which may be different from distributed system 700. The embodiment shown in FIG. 7 is thus one example of a distributed system for implementing an embodiment system and is not intended to be limiting.

Users may use client computing devices 702, 704, 706, 708, and/or 710 for techniques for pruning similar AST subtrees for code similarity search in accordance with the teachings of this disclosure. A client device may provide an interface that enables a user of the client device to interact with the client device. The client device may also output information to the user via this interface. Although FIG. 7 depicts only five client computing devices, any number of client computing devices may be supported.

The client devices may include various types of computing systems such as smart phones or other portable handheld devices, general purpose computers such as personal computers and laptops, workstation computers, personal assistant devices, smart watches, smart glasses, or other wearable devices, equipment firmware, gaming systems, thin clients, various messaging devices, sensors or other sensing devices, and the like. These computing devices may run various types and versions of software applications and operating systems (e.g., Microsoft Windows®, Apple Macintosh®, UNIX® or UNIX-like operating systems, Linux® or Linux-like operating systems such as Oracle® Linux and Google Chrome® OS) including various mobile operating systems (e.g., Microsoft Windows Mobile®, iOS®, Windows Phone®, Android®, HarmonyOS®, Tizen®, KaiOS®, Sailfish® OS, Ubuntu® Touch, CalyxOS®). Portable handheld devices may include cellular phones, smartphones, (e.g., an iPhone®), tablets (e.g., iPad®), and the like. Virtual personal assistants such as Amazon® Alexa®, Google® Assistant, Microsoft® Cortana®, Apple® Siri®, and others may be implemented on devices with a microphone and/or camera to receive user or environmental inputs, as well as a speaker and/or display to respond to the inputs. Wearable devices may include Apple® Watch, Samsung Galaxy® Watch, Meta Quest®, Ray-Ban® Meta® smart glasses, Snap® Spectacles, and other devices. Gaming systems may include various handheld gaming devices, Internet-enabled gaming devices (e.g., a Microsoft Xbox® gaming console with or without a Kinect® gesture input device, Sony PlayStation® system, Nintendo Switch®, and other devices), and the like. The client devices may be capable of executing various different applications such as various Internet-related apps, communication applications (e.g., e-mail applications, short message service (SMS) applications) and may use various communication protocols.

Network(s) 712 may be any type of network familiar to those skilled in the art that can support data communications using any of a variety of available protocols, including without limitation TCP/IP (transmission control protocol/Internet protocol), SNA (systems network architecture), IPX (Internet packet exchange), AppleTalk®, and the like. Merely by way of example, network(s) 712 can be a local area network (LAN), networks based on Ethernet, Token-Ring, a wide-area network (WAN), the Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 1002.11 suite of protocols, Bluetooth®, and/or any other wireless protocol), and/or any combination of these and/or other networks.

Server 714 may be composed of one or more general purpose computers, specialized server computers (including, by way of example, PC (personal computer) servers, UNIX® servers, LINUX© servers, mid-range servers, mainframe computers, rack-mounted servers, etc.), server farms, server clusters, a Real Application Cluster (RAC), database servers, or any other appropriate arrangement and/or combination. Server 714 can include one or more virtual machines running virtual operating systems, or other computing architectures involving virtualization such as one or more flexible pools of logical storage devices that can be virtualized to maintain virtual storage devices for the server. In various aspects, server 714 may be adapted to run one or more services or software applications that provide the functionality described in the foregoing disclosure.

The computing systems in server 714 may run one or more operating systems including any of those discussed above, as well as any commercially available server operating system. Server 714 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle®, Microsoft®, SAP®, Amazon®, Sybase®, IBM® (International Business Machines), and the like.

In some implementations, server 714 may include one or more applications to analyze and consolidate data feeds and/or event updates received from users of client computing devices 702, 704, 706, 708, and/or 710. As an example, data feeds and/or event updates may include, but are not limited to, blog feeds, Threads® feeds, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 714 may also include one or more applications to display the data feeds and/or real-time events via one or more display devices of client computing devices 702, 704, 706, 708, and/or 710.

Distributed system 700 may also include one or more data repositories 716, 718. These data repositories may be used to store data and other information in certain aspects. For example, one or more of the data repositories 716, 718 may be used to store information for techniques for pruning similar AST subtrees for code similarity search. Data repositories 716, 718 may reside in a variety of locations. For example, a data repository used by server 714 may be local to server 714 or may be remote from server 714 and in communication with server 714 via a network-based or dedicated connection. Data repositories 716, 718 may be of different types. In certain aspects, a data repository used by server 714 may be a database, for example, a relational database, a container database, an Exadata® storage device, or other data storage and retrieval tool such as databases provided by Oracle Corporation® and other vendors. One or more of these databases may be adapted to enable storage, update, and retrieval of data to and from the database in response to structured query language (SQL)-formatted commands.

In certain aspects, one or more of data repositories 716, 718 may also be used by applications to store application data. The data repositories used by applications may be of different types such as, for example, a key-value store repository, an object store repository, or a general storage repository supported by a file system.

In one embodiment, server 714 is part of a cloud-based system environment in which various services may be offered as cloud services, for a single tenant or for multiple tenants where data, requests, and other information specific to the tenant are kept private from each tenant. In the cloud-based system environment, multiple servers may communicate with each other to perform the work requested by client devices from the same or multiple tenants. The servers communicate on a cloud-side network that is not accessible to the client devices in order to perform the requested services and keep tenant data confidential from other tenants.

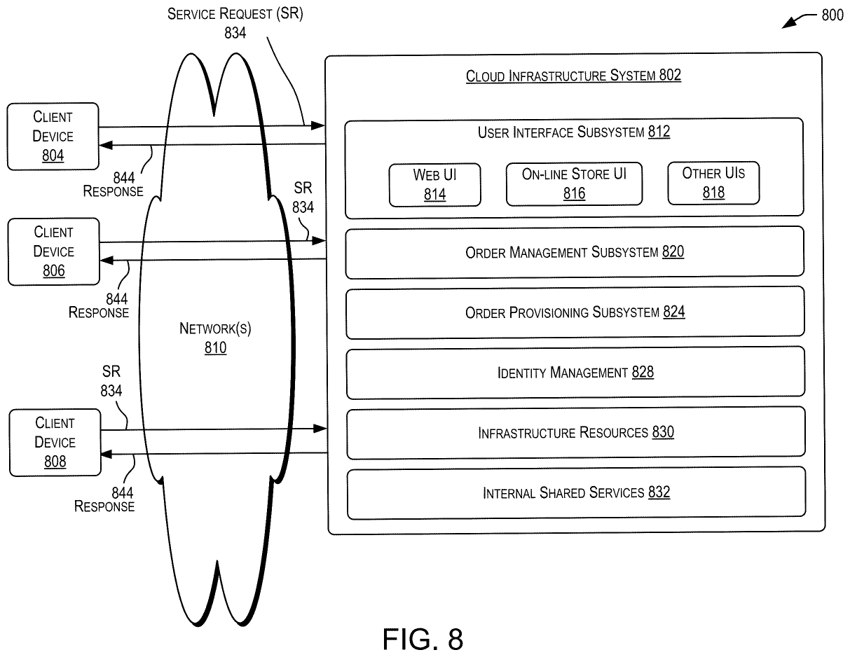

FIG. 8 is a simplified block diagram of a cloud-based system environment in which pruning similar AST subtrees for code similarity search, in accordance with certain aspects. In the embodiment depicted in FIG. 8, cloud infrastructure system 802 may provide one or more cloud services that may be requested by users using one or more client computing devices 804, 806, and 808. Cloud infrastructure system 802 may comprise one or more computers and/or servers that may include those described above for server 714. The computers in cloud infrastructure system 802 may be organized as general purpose computers, specialized server computers, server farms, server clusters, or any other appropriate arrangement and/or combination.

Network(s) 810 may facilitate communication and exchange of data between clients 804, 806, and 808 and cloud infrastructure system 802. Network(s) 810 may include one or more networks. The networks may be of the same or different types. Network(s) 810 may support one or more communication protocols, including wired and/or wireless protocols, for facilitating the communications.

The embodiment depicted in FIG. 8 is only one example of a cloud infrastructure system and is not intended to be limiting. It should be appreciated that, in some other aspects, cloud infrastructure system 802 may have more or fewer components than those depicted in FIG. 8, may combine two or more components, or may have a different configuration or arrangement of components. For example, although FIG. 8 depicts three client computing devices, any number of client computing devices may be supported in alternative aspects.

The term cloud service is generally used to refer to a service that is made available to users on demand and via a communication network such as the Internet by systems (e.g., cloud infrastructure system 802) of a service provider. Typically, in a public cloud environment, servers and systems that make up the cloud service provider's system are different from the cloud customer's (“tenant's”) own on-premise servers and systems. The cloud service provider's systems are managed by the cloud service provider. Tenants can thus avail themselves of cloud services provided by a cloud service provider without having to purchase separate licenses, support, or hardware and software resources for the services. For example, a cloud service provider's system may host an application, and a user may, via a network 810 (e.g., the Internet), on demand, order and use the application without the user having to buy infrastructure resources for executing the application. Cloud services are designed to provide easy, scalable access to applications, resources, and services. Several providers offer cloud services. For example, several cloud services are offered by Oracle Corporation®, such as database services, middleware services, application services, and others.

In certain aspects, cloud infrastructure system 802 may provide one or more cloud services using different models such as under a Software as a Service (SaaS) model, a Platform as a Service (PaaS) model, an Infrastructure as a Service (IaaS) model, a Data as a Service (DaaS) model, and others, including hybrid service models. Cloud infrastructure system 802 may include a suite of databases, middleware, applications, and/or other resources that enable provision of the various cloud services.

A SaaS model enables an application or software to be delivered to a tenant's client device over a communication network like the Internet, as a service, without the tenant having to buy the hardware or software for the underlying application. For example, a SaaS model may be used to provide tenants access to on-demand applications that are hosted by cloud infrastructure system 802. Examples of SaaS services provided by Oracle Corporation® include, without limitation, various services for human resources/capital management, client relationship management (CRM), enterprise resource planning (ERP), supply chain management (SCM), enterprise performance management (EPM), analytics services, social applications, and others.

An IaaS model is generally used to provide infrastructure resources (e.g., servers, storage, hardware, and networking resources) to a tenant as a cloud service to provide elastic compute and storage capabilities. Various IaaS services are provided by Oracle Corporation®.

A PaaS model is generally used to provide, as a service, platform and environment resources that enable tenants to develop, run, and manage applications and services without the tenant having to procure, build, or maintain such resources. Examples of PaaS services provided by Oracle Corporation® include, without limitation, Oracle Database Cloud Service (DBCS), Oracle Java Cloud Service (JCS), data management cloud service, various application development solutions services, and others.

A DaaS model is generally used to provide data as a service. Datasets may searched, combined, summarized, and downloaded or placed into use between applications. For example, user profile data may be updated by one application and provided to another application. As another example, summaries of user profile information generated based on a dataset may be used to enrich another dataset.

Cloud services are generally provided on an on-demand self-service basis, subscription-based, elastically scalable, reliable, highly available, and secure manner. For example, a tenant, via a subscription order, may order one or more services provided by cloud infrastructure system 802. Cloud infrastructure system 802 then performs processing to provide the services requested in the tenant's subscription order. Cloud infrastructure system 802 may be configured to provide one or even multiple cloud services.

Cloud infrastructure system 802 may provide the cloud services via different deployment models. In a public cloud model, cloud infrastructure system 802 may be owned by a third party cloud services provider and the cloud services are offered to any general public tenant, where the tenant can be an individual or an enterprise. In certain other aspects, under a private cloud model, cloud infrastructure system 802 may be operated within an organization (e.g., within an enterprise organization) and services provided to clients that are within the organization. For example, the clients may be various departments or employees or other individuals of departments of an enterprise such as the Human Resources department, the Payroll department, etc., or other individuals of the enterprise. In certain other aspects, under a community cloud model, the cloud infrastructure system 802 and the services provided may be shared by several organizations in a related community. Various other models such as hybrids of the above mentioned models may also be used.

Client computing devices 804, 806, and 808 may be of different types (such as devices 702, 704, 706, and 708 depicted in FIG. 7) and may be capable of operating one or more client applications. A user may use a client device to interact with cloud infrastructure system 802, such as to request a service provided by cloud infrastructure system 802.

In some aspects, the processing performed by cloud infrastructure system 802 for providing chatbot services may involve big data analysis. This analysis may involve using, analyzing, and manipulating large data sets to detect and visualize various trends, behaviors, relationships, etc. within the data. This analysis may be performed by one or more processors, possibly processing the data in parallel, performing simulations using the data, and the like. For example, big data analysis may be performed by cloud infrastructure system 802 for determining the intent of an utterance. The data used for this analysis may include structured data (e.g., data stored in a database or structured according to a structured model) and/or unstructured data (e.g., data blobs (binary large objects)).

As depicted in the embodiment in FIG. 8, cloud infrastructure system 802 may include infrastructure resources 830 that are utilized for facilitating the provision of various cloud services offered by cloud infrastructure system 802. Infrastructure resources 830 may include, for example, processing resources, storage or memory resources, networking resources, and the like.

In certain aspects, to facilitate efficient provisioning of these resources for supporting the various cloud services provided by cloud infrastructure system 802 for different tenants, the resources may be bundled into sets of resources or resource modules (also referred to as “pods”). Each resource module or pod may comprise a pre-integrated and optimized combination of resources of one or more types. In certain aspects, different pods may be pre-provisioned for different types of cloud services. For example, a first set of pods may be provisioned for a database service, a second set of pods, which may include a different combination of resources than a pod in the first set of pods, may be provisioned for Java service, and the like. For some services, the resources allocated for provisioning the services may be shared between the services.

Cloud infrastructure system 802 may itself internally use services 832 that are shared by different components of cloud infrastructure system 802 and which facilitate the provisioning of services by cloud infrastructure system 802. These internal shared services may include, without limitation, a security and identity service, an integration service, an enterprise repository service, an enterprise manager service, a virus scanning and whitelist service, a high availability, backup and recovery service, service for enabling cloud support, an email service, a notification service, a file transfer service, and the like.

Cloud infrastructure system 802 may comprise multiple subsystems. These subsystems may be implemented in software, or hardware, or combinations thereof. As depicted in FIG. 8, the subsystems may include a user interface subsystem 812 that enables users of cloud infrastructure system 802 to interact with cloud infrastructure system 802. User interface subsystem 812 may include various different interfaces such as a web interface 814, an online store interface 816 where cloud services provided by cloud infrastructure system 802 are advertised and are purchasable by a consumer, and other interfaces 818. For example, a tenant may, using a client device, request (service request 834) one or more services provided by cloud infrastructure system 802 using one or more of interfaces 814, 816, and 818. For example, a tenant may access the online store, browse cloud services offered by cloud infrastructure system 802, and place a subscription order for one or more services offered by cloud infrastructure system 802 that the tenant wishes to subscribe to. The service request may include information identifying the tenant and one or more services that the tenant desires to subscribe to. For example, a tenant may place a subscription order for a chatbot related service offered by cloud infrastructure system 802. As part of the order, the client may provide information identifying the input (e.g. utterances).

In certain aspects, such as the embodiment depicted in FIG. 8, cloud infrastructure system 802 may comprise a service management subsystem (OMS) 820 that is configured to process the new order. As part of this processing, OMS 820 may be configured to: create an account for the tenant, if not done already; receive billing and/or accounting information from the tenant that is to be used for billing the tenant for providing the requested service to the tenant; verify the tenant information; upon verification, book the order for the tenant; and orchestrate various workflows to prepare the order for provisioning.

Once properly validated, OMS 820 may then invoke the service provisioning subsystem (OPS) 824 that is configured to provision resources for the order including processing, memory, and networking resources. The provisioning may include allocating resources for the order and configuring the resources to facilitate the service requested by the tenant order. The manner in which resources are provisioned for an order and the type of the provisioned resources may depend upon the type of cloud service that has been ordered by the tenant. For example, according to one workflow, OPS 824 may be configured to determine the particular cloud service being requested and identify a number of pods that may have been pre-configured for that particular cloud service. The number of pods that are allocated for an order may depend upon the size/amount/level/scope of the requested service. For example, the number of pods to be allocated may be determined based upon the number of users to be supported by the service, the duration of time for which the service is being requested, and the like. The allocated pods may then be customized for the particular requesting tenant for providing the requested service.

Cloud infrastructure system 802 may send a response or notification 844 to the requesting tenant to indicate when the requested service is now ready for use. In some instances, information (e.g., a link) may be sent to the tenant that enables the tenant to start using and availing the benefits of the requested services.

Cloud infrastructure system 802 may provide services to multiple tenants. For each tenant, cloud infrastructure system 802 is responsible for managing information related to one or more subscription orders received from the tenant, maintaining tenant data related to the orders, and providing the requested services to the tenant or clients of the tenant. Cloud infrastructure system 802 may also collect usage statistics regarding a tenant's use of subscribed services. For example, statistics may be collected for the amount of storage used, the amount of data transferred, the number of users, and the amount of system up time and system down time, and the like. This usage information may be used to bill the tenant. Billing may be done, for example, on a monthly cycle.

Cloud infrastructure system 802 may provide services to multiple tenants in parallel. Cloud infrastructure system 802 may store information for these tenants, including possibly proprietary information. In certain aspects, cloud infrastructure system 802 comprises an identity management subsystem (IMS) 828 that is configured to manage tenant's information and provide the separation of the managed information such that information related to one tenant is not accessible by another tenant. IMS 828 may be configured to provide various security-related services such as identity services, such as information access management, authentication and authorization services, services for managing tenant identities and roles and related capabilities, and the like.

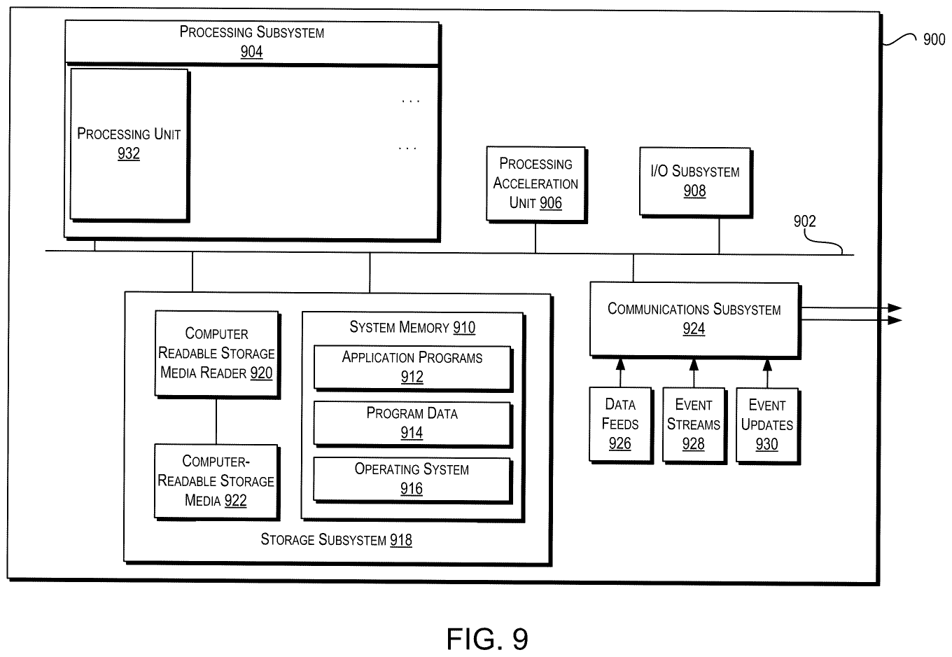

FIG. 9 illustrates an exemplary computer system 900 that may be used to implement certain aspects. As shown in FIG. 9, computer system 900 includes various subsystems including a processing subsystem 904 that communicates with a number of other subsystems via a bus subsystem 902. These other subsystems may include a processing acceleration unit 906, an I/O subsystem 908, a storage subsystem 918, and a communications subsystem 924. Storage subsystem 918 may include non-transitory and/or transitory computer-readable storage media including storage media 922 and a system memory 910.

Bus subsystem 902 provides a mechanism for letting the various components and subsystems of computer system 900 communicate with each other as intended. Although bus subsystem 902 is shown schematically as a single bus, alternative aspects of the bus subsystem may utilize multiple buses. Bus subsystem 902 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard, and the like.

Processing subsystem 904 controls the operation of computer system 900 and may comprise one or more processors, application specific integrated circuits (ASICs), or field programmable gate arrays (FPGAs). The processors may be single core or multicore processors. The processing resources of computer system 900 can be organized into one or more processing units 932, 934, etc. A processing unit may include one or more processors, one or more cores from the same or different processors, a combination of cores and processors, or other combinations of cores and processors. In some aspects, processing subsystem 904 can include one or more special purpose co-processors such as graphics processors, digital signal processors (DSPs), or the like. In some aspects, some or all of the processing units of processing subsystem 904 can be implemented using customized circuits, such as application specific integrated circuits (ASICs), or field programmable gate arrays (FPGAs).

In some aspects, the processing units in processing subsystem 904 can execute instructions stored in system memory 910 or on computer readable storage media 922. In various aspects, the processing units can execute a variety of programs or code instructions and can maintain multiple concurrently executing programs or processes. At any given time, some or all of the program code to be executed can be resident in system memory 910 and/or on computer-readable storage media 922 including potentially on one or more storage devices. Through suitable programming, processing subsystem 904 can provide various functionalities described above. In instances where computer system 900 is executing one or more virtual machines, one or more processing units may be allocated to each virtual machine.

In certain aspects, a processing acceleration unit 906 may optionally be provided for performing customized processing or for off-loading some of the processing performed by processing subsystem 904 so as to accelerate the overall processing performed by computer system 900.

I/O subsystem 908 may include devices and mechanisms for inputting information to computer system 900 and/or for outputting information from or via computer system 900. In general, use of the term input device is intended to include all possible types of devices and mechanisms for inputting information to computer system 900. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Meta Quest® controller, Microsoft Kinect® motion sensor, the Microsoft Xbox® 360 game controller, or devices that provide an interface for receiving input using gestures and spoken commands. User interface input devices may also include eye gesture recognition devices such as a blink detector that detects eye activity (e.g., “blinking” while taking pictures and/or making a menu selection) from users and transforms the eye gestures as inputs to an input device. Additionally, user interface input devices may include voice recognition sensing devices that enable users to interact with voice recognition systems (e.g., Siri® navigator or Amazon Alexa®) through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, QR code readers, barcode readers, 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments, and the like.

In general, use of the term output device is intended to include all possible types of devices and mechanisms for outputting information from computer system 900 to a user or other computer. User interface output devices may include a display subsystem, indicator lights, or non-visual displays such as audio output devices, etc. The display subsystem may be any device for outputting a digital picture. Example display devices include flat panel display devices such as those using a light emitting diode (LED) display, a liquid crystal display (LCD) or plasma display, a projection device, a touch screen, a desktop or laptop computer monitor, and the like. As another example, wearable display devices such as Meta Quest® or Microsoft HoloLens® may be mounted to the user for displaying information. User interface output devices may include, without limitation, a variety of display devices that visually convey text, graphics, and audio/video information such as monitors, printers, speakers, headphones, automotive navigation systems, plotters, voice output devices, and modems.

Storage subsystem 918 provides a repository or data store for storing information and data that is used by computer system 900. Storage subsystem 918 provides a tangible non-transitory computer-readable storage medium for storing the basic programming and data constructs that provide the functionality of some aspects. Storage subsystem 918 may store software (e.g., programs, code modules, instructions) that when executed by processing subsystem 904 provides the functionality described above. The software may be executed by one or more processing units of processing subsystem 904. Storage subsystem 918 may also provide a repository for storing data used in accordance with the teachings of this disclosure.

Storage subsystem 918 may include one or more non-transitory memory devices, including volatile and non-volatile memory devices. As shown in FIG. 9, storage subsystem 918 includes a system memory 910 and a computer-readable storage media 922. System memory 910 may include a number of memories including a volatile main random access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 900, such as during start-up, may typically be stored in the ROM. The RAM typically contains data and/or program modules that are presently being operated and executed by processing subsystem 904. In some implementations, system memory 910 may include multiple different types of memory, such as static random access memory (SRAM), dynamic random access memory (DRAM), and the like.

By way of example, and not limitation, as depicted in FIG. 9, system memory 910 may load application programs 912 that are being executed, which may include various applications such as Web browsers, mid-tier applications, relational database management systems (RDBMS), etc., program data 914, and an operating system 916. By way of example, operating system 916 may include various versions of Microsoft Windows®, Apple Macintosh®, and/or Linux® operating systems, a variety of commercially-available UNIX® or UNIX-like operating systems (including without limitation the variety of GNU/Linux operating systems, the Oracle Linux®, Google Chrome® OS, and the like) and/or mobile operating systems such as iOS, Windows® Phone, Android® OS, and others.

Computer-readable storage media 922 may store programming and data constructs that provide the functionality of some aspects. Computer-readable media 922 may provide storage of computer-readable instructions, data structures, program modules, and other data for computer system 900. Software (programs, code modules, instructions) that, when executed by processing subsystem 904 provides the functionality described above, may be stored in storage subsystem 918. By way of example, computer-readable storage media 922 may include non-volatile memory such as a hard disk drive, a magnetic disk drive, an optical disk drive such as a CD ROM, digital video disc (DVD), a Blu-Ray® disk, or other optical media. Computer-readable storage media 922 may include, but is not limited to, Zip® drives, flash memory cards, universal serial bus (USB) flash drives, secure digital (SD) cards, DVD disks, digital video tape, and the like. Computer-readable storage media 922 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, dynamic random access memory (DRAM)-based SSDs, magnetoresistive RAM (MRAM) SSDs, and hybrid SSDs that use a combination of DRAM and flash memory based SSDs.

In certain aspects, storage subsystem 918 may also include a computer-readable storage media reader 920 that can further be connected to computer-readable storage media 922. Reader 920 may receive and be configured to read data from a memory device such as a disk, a flash drive, etc.

In certain aspects, computer system 900 may support virtualization technologies, including but not limited to virtualization of processing and memory resources. For example, computer system 900 may provide support for executing one or more virtual machines. In certain aspects, computer system 900 may execute a program such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 900. Accordingly, multiple operating systems may potentially be run concurrently by computer system 900.

Communications subsystem 924 provides an interface to other computer systems and networks. Communications subsystem 924 serves as an interface for receiving data from and transmitting data to other systems from computer system 900. For example, communications subsystem 924 may enable computer system 900 to establish a communication channel to one or more client devices via the Internet for receiving and sending information from and to the client devices. For example, the communications subsystem may be used to transmit a response to a user regarding the inquiry for a chatbot.

Communications subsystem 924 may support both wired and/or wireless communication protocols. For example, in certain aspects, communications subsystem 924 may include radio frequency (RF) transceiver components for accessing wireless voice and/or data networks (e.g., using cellular telephone technology, advanced data network technology, such as 3G, 4G or EDGE (enhanced data rates for global evolution), Wi-Fi (IEEE 802.XX family standards, or other mobile communication technologies, or any combination thereof), global positioning system (GPS) receiver components, and/or other components. In some aspects communications subsystem 924 can provide wired network connectivity (e.g., Ethernet) in addition to or instead of a wireless interface.

Communications subsystem 924 can receive and transmit data in various forms. For example, in some aspects, in addition to other forms, communications subsystem 924 may receive input communications in the form of structured and/or unstructured data feeds 926, event streams 928, event updates 930, and the like. For example, communications subsystem 924 may be configured to receive (or send) data feeds 926 in real-time from users of social media networks and/or other communication services such as Twitter® feeds, Facebook® updates, web feeds such as Rich Site Summary (RSS) feeds, and/or real-time updates from one or more third party information sources.

In certain aspects, communications subsystem 924 may be configured to receive data in the form of continuous data streams, which may include event streams 928 of real-time events and/or event updates 930, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 924 may also be configured to communicate data from computer system 900 to other computer systems or networks. The data may be communicated in various different forms such as structured and/or unstructured data feeds 926, event streams 928, event updates 930, and the like to one or more databases that may be in communication with one or more streaming data source computers coupled to computer system 900.

Computer system 900 can be one of various types, including a handheld portable device (e.g., an iPhone® cellular phone, an iPad® computing tablet, a personal digital assistant (PDA)), a wearable device (e.g., a Meta Quest® head mounted display), a personal computer, a workstation, a mainframe, a kiosk, a server rack, or any other data processing system. Due to the ever-changing nature of computers and networks, the description of computer system 900 depicted in FIG. 9 is intended only as a specific example. Many other configurations having more or fewer components than the system depicted in FIG. 9 are possible. Based on the disclosure and teachings provided herein, a person of ordinary skill in the art can appreciate other ways and/or methods to implement the various aspects.

Although specific aspects have been described, various modifications, alterations, alternative constructions, and equivalents are possible. Embodiments are not restricted to operation within certain specific data processing environments, but are free to operate within a plurality of data processing environments. Additionally, although certain aspects have been described using a particular series of transactions and steps, it should be apparent to those skilled in the art that this is not intended to be limiting. Although some flowcharts describe operations as a sequential process, many of the operations can be performed in parallel or concurrently. In addition, the order of the operations may be rearranged. A process may have additional steps not included in the figure. Various features and aspects of the above-described aspects may be used individually or jointly.

Further, while certain aspects have been described using a particular combination of hardware and software, it should be recognized that other combinations of hardware and software are also possible. Certain aspects may be implemented only in hardware, or only in software, or using combinations thereof. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Specific details are given in this disclosure to provide a thorough understanding of the aspects. However, aspects may be practiced without these specific details. For example, well-known circuits, processes, algorithms, structures, and techniques have been shown without unnecessary detail in order to avoid obscuring the aspects. This description provides example aspects only, and is not intended to limit the scope, applicability, or configuration of other aspects. Rather, the preceding description of the aspects can provide those skilled in the art with an enabling description for implementing various aspects. Various changes may be made in the function and arrangement of elements.

The specification and drawings are, accordingly, to be regarded in an illustrative rather than a restrictive sense. It can, however, be evident that additions, subtractions, deletions, and other modifications and changes may be made thereunto without departing from the broader spirit and scope as set forth in the claims. Thus, although specific aspects have been described, these are not intended to be limiting. Various modifications and equivalents are within the scope of the following claims.

What is claimed is:

1. A computer-implemented method comprising:
accessing a set of code for which to generate an index for code retrieval from the set of code;
determining a hierarchy of candidate subsets of the set of code for which to make a determination whether to separately store vector embeddings of the candidate subsets in the index for code retrieval from the set of code;
for a particular subset of the hierarchy of candidate subsets, determining an ancestor that is closest to the particular subset and for which a determination has been made to separately store a vector embedding in the index for code retrieval from the set of code;
determining a relative amount of content of the ancestor that is shared by the particular subset;
generating and storing, in the index for code retrieval from the set of code, a particular vector embedding of the particular subset based at least in part on determining that the relative amount does not satisfy a threshold;
for another particular subset of the hierarchy of candidate subsets, determining another ancestor that is closest to the other particular subset and for which another determination has been made to separately store another vector embedding in the index for code retrieval from the set of code;
determining another relative amount of content of the other ancestor that is shared by the other particular subset;
determining not to separately store a vector embedding specific to the other particular subset in the index based at least in part on determining that the other relative amount satisfies the threshold;
storing the other vector embedding of the other ancestor in the index for code retrieval from the set of code;
using the index to identify code similar to a content vector embedding.

2. The computer-implemented method of claim 1, further comprising identifying the hierarchy of candidate subsets of the set of code using an abstract syntax tree.

3. The computer-implemented method of claim 2, further comprising identifying the hierarchy of candidate subsets of the set of code by identifying one or more subtrees of the abstract syntax tree.

4. The computer-implemented method of claim 2, further comprising identifying a candidate subset of the set of code based on the candidate subset being associated with a node having at least one child node in the abstract syntax tree.

5. The computer-implemented method of claim 1, wherein the other particular subset is an ancestor of the particular subset, and wherein the ancestor is a superset of the particular subset and the other particular subset.

6. The computer-implemented method of claim 1, wherein the particular subset is the other ancestor of the other particular subset, and wherein the particular subset is a superset of the other particular subset.

7. The computer-implemented method of claim 1, wherein using the index to identify code similar to a content vector embedding comprises:
determining a cosine similarity between the content vector embedding and each of the ancestor vector embedding, the other ancestor vector embedding, and the particular vector embedding; and
selecting, as similar, one of the ancestor vector embedding, the other ancestor vector embedding, or the particular vector embedding without selecting, as similar, at least one other of the ancestor vector embedding, the other ancestor vector embedding, or the particular vector embedding.

8. The computer-implemented method of claim 1, wherein using the index to identify code similar to a content vector embedding comprises:
determining a cosine similarity between the content vector embedding and each of the ancestor vector embedding and the particular vector embedding; and
selecting, as similar, the particular vector embedding without selecting, as similar, the ancestor vector embedding.

9. The computer-implemented method of claim 1, further comprising determining the content vector embedding based on a search query comprising natural language content describing code.

10. The computer-implemented method of claim 1, wherein the particular vector embedding is based at least in part on a large language model output from analyzing content of the particular subset.

11. A computer-program product comprising one or more non-transitory machine-readable storage media, including stored instructions configured to cause a computing system to perform a set of actions including:
accessing a set of code for which to generate an index for code retrieval from the set of code;
determining a hierarchy of candidate subsets of the set of code for which to make a determination whether to separately store vector embeddings of the candidate subsets in the index for code retrieval from the set of code;
for a particular subset of the hierarchy of candidate subsets, determining an ancestor that is closest to the particular subset and for which a determination has been made to separately store a vector embedding in the index for code retrieval from the set of code;
determining a relative amount of content of the ancestor that is shared by the particular subset;
generating and storing, in the index for code retrieval from the set of code, a particular vector embedding of the particular subset based at least in part on determining that the relative amount does not satisfy a threshold;
for another particular subset of the hierarchy of candidate subsets, determining another ancestor that is closest to the other particular subset and for which another determination has been made to separately store another vector embedding in the index for code retrieval from the set of code;
determining another relative amount of content of the other ancestor that is shared by the other particular subset;
determining not to separately store a vector embedding specific to the other particular subset in the index based at least in part on determining that the other relative amount satisfies the threshold;
storing the other vector embedding of the other ancestor in the index for code retrieval from the set of code;
using the index to identify code similar to a content vector embedding.

12. The computer-program product of claim 11, wherein the set of actions further includes:
identifying the hierarchy of candidate subsets of the set of code using an abstract syntax tree.

13. The computer-program product of claim 12, wherein the set of actions further includes:
identifying the hierarchy of candidate subsets of the set of code by identifying one or more subtrees of the abstract syntax tree.

14. The computer-program product of claim 11, wherein the set of actions further includes:
identifying a candidate subset of the set of code based on the candidate subset being associated with a node having at least one child node in the abstract syntax tree.

15. The computer-program product of claim 11, wherein the other particular subset is an ancestor of the particular subset, and wherein the ancestor is a superset of the particular subset and the other particular subset.

16. A system comprising:
one or more processors;
one or more non-transitory computer-readable media storing instructions, which, when executed by the system, cause the system to perform a set of actions including:
accessing a set of code for which to generate an index for code retrieval from the set of code;
determining a hierarchy of candidate subsets of the set of code for which to make a determination whether to separately store vector embeddings of the candidate subsets in the index for code retrieval from the set of code;
for a particular subset of the hierarchy of candidate subsets, determining an ancestor that is closest to the particular subset and for which a determination has been made to separately store a vector embedding in the index for code retrieval from the set of code;
determining a relative amount of content of the ancestor that is shared by the particular subset;
generating and storing, in the index for code retrieval from the set of code, a particular vector embedding of the particular subset based at least in part on determining that the relative amount does not satisfy a threshold;
for another particular subset of the hierarchy of candidate subsets, determining another ancestor that is closest to the other particular subset and for which another determination has been made to separately store another vector embedding in the index for code retrieval from the set of code;
determining another relative amount of content of the other ancestor that is shared by the other particular subset;
determining not to separately store a vector embedding specific to the other particular subset in the index based at least in part on determining that the other relative amount satisfies the threshold;
storing the other vector embedding of the other ancestor in the index for code retrieval from the set of code;
using the index to identify code similar to a content vector embedding.

17. The system of claim 16, wherein using the index to identify code similar to a content vector embedding comprises:
determining a cosine similarity between the content vector embedding and each of the ancestor vector embedding, the other ancestor vector embedding, and the particular vector embedding; and
selecting, as similar, one of the ancestor vector embedding, the other ancestor vector embedding, or the particular vector embedding without selecting, as similar, at least one other of the ancestor vector embedding, the other ancestor vector embedding, or the particular vector embedding.

18. The system of claim 16, wherein using the index to identify code similar to a content vector embedding comprises:
determining a cosine similarity between the content vector embedding and each of the ancestor vector embedding and the particular vector embedding; and
selecting, as similar, the particular vector embedding without selecting, as similar, the ancestor vector embedding.

19. The system of claim 16, wherein the set of actions further includes:
determining the content vector embedding based on a search query comprising natural language content describing code.

20. The system of claim 16, wherein the particular vector embedding is based at least in part on a large language model output from analyzing content of the particular subset.
